(19) United States
(12) Patent Application Publication
(10) Pub. No.: US 2014/0201529 A1
(43) Pub. Date: Jul. 17, 2014

(54) Method for Communication between Gateways in Wireless Sensor Network (WSN), Initiating Party Gateway and Destination Party Gateway

(71) Applicant: Jingwang Ma, Shenzhen (CN)

(72) Inventor: Jingwang Ma, Shenzhen (CN)

(73) Assignee: ZTE CORPORATION, Shenzhen, GD (CN)

(21) Appl. No.: 13/977,750

(22) PCT Filed: Jan. 4, 2012
(86) PCT No.: PCT/CN12/70032

§ 371 Date: Mar. 21, 2014

(30) Foreign Application Priority Data
Jul. 20, 2011 (CN) 201110204033.4

(51) Int. Cl. H04W 12/06; H04L 9/32

(52) U.S. Cl. CPC H04W 12/06; H04L 9/32
USPC 713/168; 726/3

(57) ABSTRACT

The disclosure provides a method for communication between gateways in Wireless Sensor Network (WSN), comprising: in a WSN configured with a plurality of gateways, an initiating gateway determining a target gateway with which a telecommunication network communication connection is to be established; the initiating gateway and the target gateway performing authentication, after the authentication is successful, establishing the telecommunication network communication connection between the initiating gateway and the target gateway. The disclosure also discloses an initiating gateway and a target gateway in a WSN. Via solutions of the disclosure, the increase of loads of the WSN caused by communication between gateways inside the WSN can be avoided, and the security of communication between gateways is guaranteed.

### TECHNICAL FIELD

The disclosure relates to a communication technology in which a Wireless Sensor Network (WSN) is combined with a telecommunication network, in particular to a method for communication between gateways in a WSN, an initiating gateway and a target gateway.

### BACKGROUND

As a product of computation, communication and sensor technologies, a WSN is a novel information acquisition and processing technology. Due to improvements of micro-manufacturing technologies, communication technologies and battery technologies in recent years, minute WSN terminals have capabilities of sensing, wireless communication and information processing. Such WSN terminals can not only sense and detect targets in an environment and change of the targets, but also process collected data and send the processed data to a data collection center by means of wireless transmission. These WSN terminals usually consist of several parts: power supply, a sensing component, an embedded processor, a memory, a communication component and software. The power supply provides power required by a sensor node to work normally. The sensing component is configured to sense and acquire external information and convert the external information into digital signals. The embedded processor is responsible for coordinating the operation of each part of a node, for example, processing if necessary and storing the external information acquired by the sensing component, controlling a working mode of the sensing component and the power supply, or the like. The communication component is responsible for communicating with other sensors or observers. The software provides essential software support, such as an embedded operating system, an embedded database system or the like, for the sensor node. In aid of various built-in sensing components of the WSN terminals, heat, infrared, sonar, radar and seismic wave signals in the environment all around are measured, thus various physical phenomena including temperature, humidity, noise, light intensity, pressure, soil constituent, and size, speed and direction of moving objects or the like are detected. The WSN terminals generally form a network by means of self-organization or pre-configuration. In terms of the communication mode, although various ways such as wired communication, wireless communication, infrared communication and optical communication can be employed, it is generally regarded that short-distance wireless low-power communication technologies fit the sensor network best, an the sensor network adopting the short-distance wireless low-power communication technologies is usually called WSN. At present, the wireless low-power communication technologies with relatively broad application include: Institute of Electrical and Electronics Engineers 802.15.4, Zigbee technology or the like. Similar to the Bluetooth, the Zigbee is a novel short-distance wireless technology.

The IEEE 802.15.4 is a low-speed wireless personal area network standard developed by the IEEE. The IEEE 802.15.4 specifies a standard for a physical layer and a media access control layer, and communication modules meeting the IEEE 802.15.4 standard have advantages of low cost, low power consumption and small size.

The Zigbee union is an organization engaged in development of reliable, low-cost and low-power-consumption monitoring and controlling products with a wireless network connection, on the basis of an open global standard. In the Zigbee standard, the physical layer and the media access control layer employ the IEEE 802.15.4 technology, while the intercommunity and the specification of a network layer, security management and application layer are developed by the Zigbee union. In the Zigbee standard, a Zigbee smart energy public applications profile and a Zigbee home automation public applications profile are respectively designed for business application and home application.

The micro-processing capability and wireless communication capability of the WSN terminals promise the WSN a broad application prospect, the application of the WSN includes military application, biologic and environmental monitoring, health application, home application, industrial control and monitoring, or the like.

Combination of the WSN and telecommunication networks, such as 2G mobile communication, 3G mobile communication, x Digital Subscriber line (xDSL), Fiber To The x (FTTx), broadband wireless access, satellite/microwave or the like, enables the WSN as extension of the existing networks to expand the capability of the communication network, so that the communication objects are expanded to physical world from human being. Therefore, the combination of the WSN and the telecommunication networks has excellent development prospect. With the combination of the WSN and the existing telecommunication networks, data sensed by the sensing network can be effectively transferred to a data center. By sorting and analyzing the data, the way that human acquires the data of the natural world can be greatly changed, simultaneously, centralized management of the WSN also can be achieved, so that the present problem that it is difficult to manage scattered WSNs is solved.

The combination of the WSN and the telecommunication network is to connect the WSN with the telecommunication network, so that the telecommunication network can be adopted to monitor and manage the WSN and services provided by the WSN, complete bearing of services and cooperative implementation, and expand services provided by the WSN. The combination of the WSN and the telecommunication network is usually to connect the WSN to a telecommunication network platform via a gateway device.

When the WSN is combined with the telecommunication work, the system architecture diagram of accessing a plurality of WSN terminals in the WSN to the telecommunication network is shown in FIG. 1. The shaded portions filled with cross lines in FIG. 1 represent a plurality of WSN terminals, the shaded portion filled with dots represents the area where the plurality of WSN terminals locate. The system architecture in FIG. 1 will be specifically illustrated below.

In FIG. 1, the WSN consists of a plurality of WSN terminals and a plurality of gateways. The plurality of WSN terminals and the plurality of gateways can form the WSN according to relevant technology standards of the WSN, and near-distance communication technologies that can be used for forming the WSN include: the Zigbee technology, the IEEE 802.15.4 standard or the like. The WSN is connected to the telecommunication network via a plurality of gateways to establish communication with a WSN management platform in the telecommunication network. A master-slave gateway working mode and a peer-to-peer working mode can be employed between the gateways.

The WSN is accessed to the telecommunication network via a plurality of gateways and connected with the access network, the core network, the service platform and the WSN management platform via the telecommunication network, so that the connection between the WSN and the telecommunication network is achieved.

The WSN terminals are sensor nodes in the WSN and are connected with the gateways by means of one hop or multiple hops. The WSN terminals are responsible for acquiring and uploading data and receiving and executing commands. The number of WSN terminals forming the WSN varies from several to hundreds, and the WSN terminals may perform networking in a way of star, tree or mesh according to actual demands, wherein some WSN terminals have strong networking and data forwarding capabilities. In the WSN, gateways are responsible for sending data reported by the WSN terminals to relevant network units in the telecommunication network, and then the relevant network units in the telecommunication network send relevant instructions to the WSN terminals via the gateways. Moreover, when the WSN employs the common IEEE 802.15.4 and Zigbee technology, the gateways are generally responsible for creating the WSN and performing management when the WSN terminals joins or leaves the WSN. Important data such as configuration information of the WSN terminals and service configuration information of the WSN are stored in the gateways.

Data reported by the WSN terminals need to be sent to the relevant network units in the telecommunication network via the gateways. However, in the existing WSN, only one gateway is usually configured to forward the data reported by the WSN terminals to the relevant network units in the telecommunication network. Therefore, when there are many WSN terminals in the WSN, or when WSN terminals report data frequently, great loads may be caused to the gateway in the WSN, as a result, data from the WSN terminals cannot be sent timely, and communication between the WSN terminals and the gateway is congested. In this case, the normal working of the WSN is influenced seriously. Besides, when managing the WSN terminals in the WSN, the network units at the telecommunication network side need to establish communication with the WSN terminals via the gateway in the WSN; if the network units at the telecommunication network side establish communication with the WSN terminals in the WSN via only one gateway, large bearing pressure also may be caused to the gateway, as a result, the network units at the telecommunication network side cannot establish communication with the WSN terminals in the WSN timely, which influences the normal operation of relevant services. Therefore, problems, such as how the relevant network units at the telecommunication network side communicate with the WSN terminals in the WSN, have to be considered. For this problem, one feasible solution is that the WSN is configured with a plurality of gateways, the WSN terminals in the WSN report data via these gateways and the network units at the telecommunication network side establish communication with the WSN terminals via these gateways.

In a WSN configured with a plurality of gateways, the gateways have to establish communication connection for coordination and cooperation with each other, and then transmit relevant messages and data via the established communication connection, so as to complete relevant functions. In order to be able to distinguish two gateways in communication, the gateway initiating communication is called an initiating gateway, the target gateway to which the initiating gateway initiates communication is called a target gateway. Each gateway is a node in the WSN and gateways can communicate with each other via the WSN. However, if communication between gateways is established inside the WSN and relevant messages and data are transmitted, the communication loads of the WSN will be increased, which may cause delay of data report by the WSN terminals, thereby bringing a bad effect on the relevant services in the WSN.

### SUMMARY

In view of the above, the disclosure provides a method for communication between gateways in a WSN, an initiating gateway and a target gateway, so that the increase of loads of the WSN caused by communication between gateways inside the WSN can be avoided, and security of the communication between gateways is guaranteed.

The technical solutions of the disclosure are implemented as follows.

The disclosure provides a method for communication between gateways in a WSN, including:

in a WSN configured with a plurality of gateways, an initiating gateway determining a target gateway with which a telecommunication network communication connection is to be established;

the initiating gateway and the target gateway performing authentication, after the authentication is successful, establishing the telecommunication network communication connection between the initiating gateway and the target gateway.

In the above solution, the initiating gateway determining the target gateway in a telecommunication network is:

in the WSN configured with the plurality of gateways, each gateway storing network information about other gateways in the WSN;

the initiating gateway determining the target gateway, with which the telecommunication network communication connection is to be established, according to the stored network information about other gateways in the WSN.

In the above solution, each gateway storing the network information about other gateways in the WSN is: a management platform and a gateway which creates the WSN storing the network information about each gateway in the WSN, the management platform or the gateway which creates the WSN sending the network information about all gateways in the WSN to each gateway in the WSN, and each gateway in the WSN storing the network information about other gateways except the gateway itself after receiving the network information about all gateways in the WSN.

In the above solution, the network information comprises an identity (ID) of a gateway, an address of the gateway in the telecommunication network and an address of the gateway in the WSN.

In the above solution, the initiating gateway and the target gateway performing the authentication is:

the initiating gateway and the target gateway performing mutual authentication according to authentication information stored in respective gateways, wherein the authentication information is a key used by the initiating gateway and the target gateway for communication in the WSN.

In the above solution, the initiating gateway and the target gateway performing the mutual authentication according to the authentication information stored in the respective gateways is:

after determining that the authentication information for performing communication with the target gateway is stored in the initiating gateway, the initiating gateway sending a connection establishment request to the target gateway;

the initiating gateway performing authentication for the target gateway by a symmetric-key-based authentication protocol according to the authentication information which is stored in the initiating gateway and is required for performing telecommunication network communication with the target gateway;

the target gateway which receives the connection establishment request performing authentication for the initiating gateway by the symmetric-key-based authentication protocol according to the authentication information which is stored in the target gateway and is used for performing communication with the initiating gateway.

In the above solution, the method further comprises: after determining that the authentication information for performing communication with the target gateway is not stored in the initiating gateway, the initiating gateway negotiating with the target gateway about the authentication information for performing the telecommunication network communication according to a communication technology employed in the WSN.

In the above solution, the initiating gateway negotiating the authentication information for performing the telecommunication network communication with the target gateway according to the communication technology employed in the WSN is:

when the WSN employs a Zigbee communication technology, the initiating gateway and the target gateway employing a symmetric-key key establishment protocol to determine a link key according to a master key which is possessed by both the initiating gateway and the target gateway, and storing the link key respectively as the authentication information between the initiating gateway and the target gateway.

In the above solution, the method further comprises: the communication between the initiating gateway and the target gateway in the telecommunication network employing an encryption key, which is used in the WSN, for encryption or decryption of data transmission.

The disclosure provides an initiating gateway in a Wireless Sensor Network (WSN), the initiating gateway comprises: a target gateway determination module and a first communication establishment module; wherein

the target gateway determination module is configured to, in a WSN configured with a plurality of gateways, determine a target gateway with which a telecommunication network communication connection is to be established;

the first communication establishment module is configured to perform authentication with the target gateway, and after the authentication is successful, establish the telecommunication network communication connection.

In the above solution, the initiating gateway further comprises:

a first network information storing module, configured to store network information about other gateways in the WSN;

correspondingly, the target gateway determination module is configured to determine the target gateway, with which the telecommunication network communication connection is to be established, according to the network information stored by the first network information storing module about other gateways in the WSN.

In the above solution, the initiating gateway further comprises:

a first authentication information module, configured to notify the first communication establishment module after determining that authentication information for performing communication with the target gateway is stored in the first authentication information module;

correspondingly, the first communication establishment module is configured to perform the authentication with the target gateway according to the authentication information stored in the first authentication information module.

In the above solution, the first authentication information module is further configured to, after determining that the authentication information for performing communication with the target gateway is not stored in the first authentication information module, negotiate with the target gateway about the authentication information for performing telecommunication network communication according to a communication technology employed in the WSN.

The disclosure provides a target gateway in a WSN, wherein the target gateway comprises: an initiating gateway determination module and a second communication establishment module; wherein

the initiating gateway determination module is configured to determine an initiating gateway with which a telecommunication network communication connection is to be established;

the second communication establishment module is configured to perform authentication with the initiating gateway, and after the authentication is successful, establish the telecommunication network communication connection.

In the above solution, the target gateway further comprises:

a second network information storing module, configured to store network information about other gateways in the WSN;

correspondingly, the initiating gateway determination module is configured to determine the initiating gateway, with which the telecommunication network communication connection is to be established, according to the network information stored by the second network information storing module about other gateways in the WSN.

In the above solution, the target gateway further comprises:

a second authentication information module, configured to store authentication information for performing communication with the initiating gateway;

correspondingly, the second communication establishment module is configured to perform the authentication with the initiating gateway according to the authentication information stored in the second authentication information module.

The disclosure provides a method for communication between gateways in a WSN, an initiating gateway and a target gateway. In a WSN configured with a plurality of gateways, an initiating gateway determines a target gateway with which a telecommunication network communication connection is to be established; the initiating gateway and the target gateway performs authentication, after the authentication is successful, a telecommunication network communication connection is established between the initiating gateway and the target gateway. In this way, the increase of loads of the WSN caused by communication between gateways inside the WSN can be avoided, and the security of communication between gateways is guaranteed.

### BRIEF DESCRIPTION OF THE DRAWINGS

FIG. 1 is a schematic diagram for the network architecture when there are a plurality of gateways in the related art;

FIG. 2 is a flow chart of a method for communication between gateways in a WSN in an embodiment of the disclosure;

FIG. 3 is a structure diagram of an initiating gateway in a WSN in an embodiment of the disclosure; FIG. 4 is a structure diagram of a target gateway in a WSN in an embodiment of the disclosure.

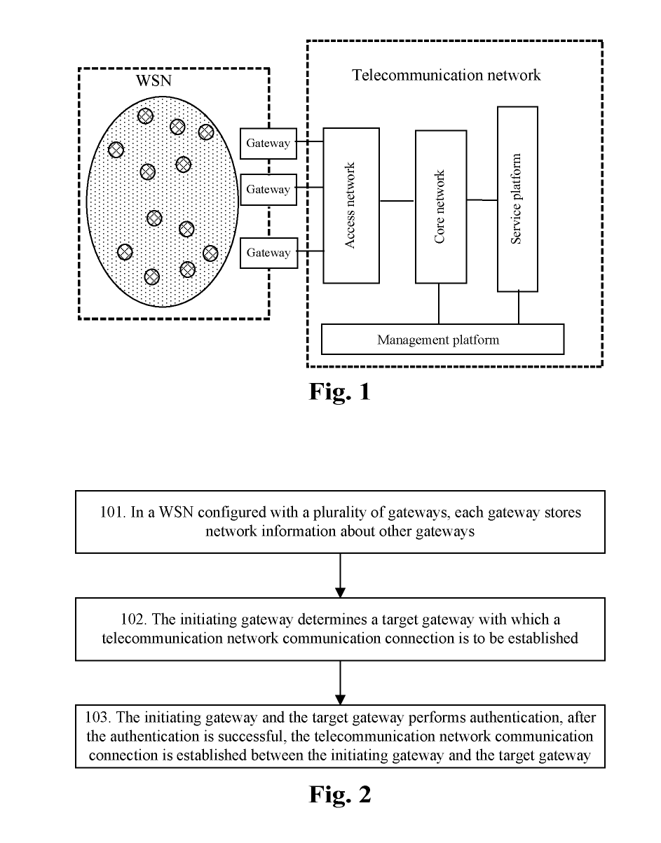

### DETAILED DESCRIPTION OF THE EMBODIMENTS

The basic principle of the embodiments of the disclosure is that: in a WSN configured with a plurality of gateways, an initiating gateway determines a target gateway with which a telecommunication network communication connection is to be established; the initiating gateway and the target gateway performs authentication, after the authentication is successful, a telecommunication network communication connection is established between the initiating gateway and the target gateway.

The disclosure will be further described in details below with reference to drawings and specific embodiments.

An embodiment of the disclosure provides a method for communication between gateways in a WSN, as shown in FIG. 2, the method includes the following steps.

Step 101: In a WSN configured with a plurality of gateways, each gateway stores network information about other gateways.

Specifically, a management platform and a gateway creating the WSN store the network information about each gateway in the WSN configured with a plurality of gateways, the management platform or the gateway creating the WSN sends the network information about all gateways in the WSN to each one of the gateways in the WSN, each one of the gateways in the WSN stores the network information about other gateways except the gateway itself after receiving the network information about each gateway in the WSN.

The management platform is arranged in the telecommunication network and can send network information about all gateways in the WSN to each one of the gateways in the WSN via the telecommunication network. The gateway creating the WSN can establish communication connections with other gateways via the WSN, and send the network information about all gateways in the WSN to each one of the gateways in the WSN.

The network information includes an identity (ID) of a gateway, an address of the gateway in the telecommunication network, an address of the gateway in the WSN or the like. The address of the gateway in the telecommunication network is generally an IP address.

Step 102: The initiating gateway determines a target gateway with which a telecommunication network communication connection is to be established.

In this step, the initiating gateway needs to establish a telecommunication network communication connection with other gateways in the WSN due to service requirements or the like, then the initiating gateway determines information such as the ID of the target gateway, the address of the target gateway in the telecommunication network and the address of the target gateway in the WSN according to the stored network information about all gateways in the WSN.

Step 103: The initiating gateway and the target gateway performs authentication, after the authentication is successful, the telecommunication network communication connection is established between the initiating gateway and the target gateway.

This step specifically includes Step 103a to Step 103d, which are described as follows.

Step 103a: After determining that authentication information for performing communication with the target gateway is stored in the initiating gateway, the initiating gateway sends a connection establishment request to the target gateway.

Specifically, the initiating gateway checks whether the authentication information required for performing telecommunication network communication with the target gateway is stored in the initiating gateway, if so, the initiating gateway sends a connection establishment request to the target gateway by a point-to-point communication protocol; otherwise, the initiating gateway negotiates with the target gateway about the authentication information required for performing telecommunication network communication according to a communication technology employed in the WSN.

The initiating gateway negotiates with the target gateway about the authentication information required for performing telecommunication network communication according to the communication technology employed in the WSN. For example, when the WSN employs the Zigbee communication technology, the initiating gateway and the target gateway employ a Symmetric-Key Key Establishment (SKKE) protocol to determine a link key according to a master key which is possessed by both the initiating gateway and the target gateway, wherein the link key serves as the authentication information between the initiating gateway and the target gateway.

The initiating gateway and the target gateway store the determined authentication information which can be used for performing telecommunication network communication between the initiating gateway and the target gateway within a period of time. In this way, when performing communication via the telecommunication network, the initiating gateway and the target gateway do not have to negotiate about the authentication information for performing communication in the telecommunication network each time.

The authentication information is generally a key used by the initiating gateway and the target gateway for performing communication in the WSN, for example, the above link key or the like.

Step 103b: The initiating gateway and the target gateway performs mutual authentication according to the authentication information stored in respective gateways.

Specifically, the initiating gateway performs authentication for the target gateway by a symmetric-key-based authentication protocol according to the authentication information which is stored in the initiating gateway and is required for performing telecommunication network communication with the target gateway; the target gateway receiving the connection establishment request acquires information, such as the ID of the initiating gateway and the address of the initiating gateway in the telecommunication network, according to the network information about all gateways in the WSN stored in the target gateway, and performs authentication for the initiating gateway by the symmetric-key-based authentication protocol according to the authentication information which is stored in the target gateway and is used for performing communication with the initiating gateway.

Step 103c: After the mutual authentication is successful, the target gateway sends a connection establishment completion response to the initiating gateway.

Step 103d: The initiating gateway receiving the connection establishment completion response performs communication with the target gateway in the telecommunication network.

In this step, the communication in the telecommunication network means that communication is performed according to information, such as the address, of the two parties in the telecommunication network.

Moreover, the communication between the initiating gateway and the target gateway in the telecommunication network employs an encryption key, which is used in the WSN, for encryption or decryption of data transmission.

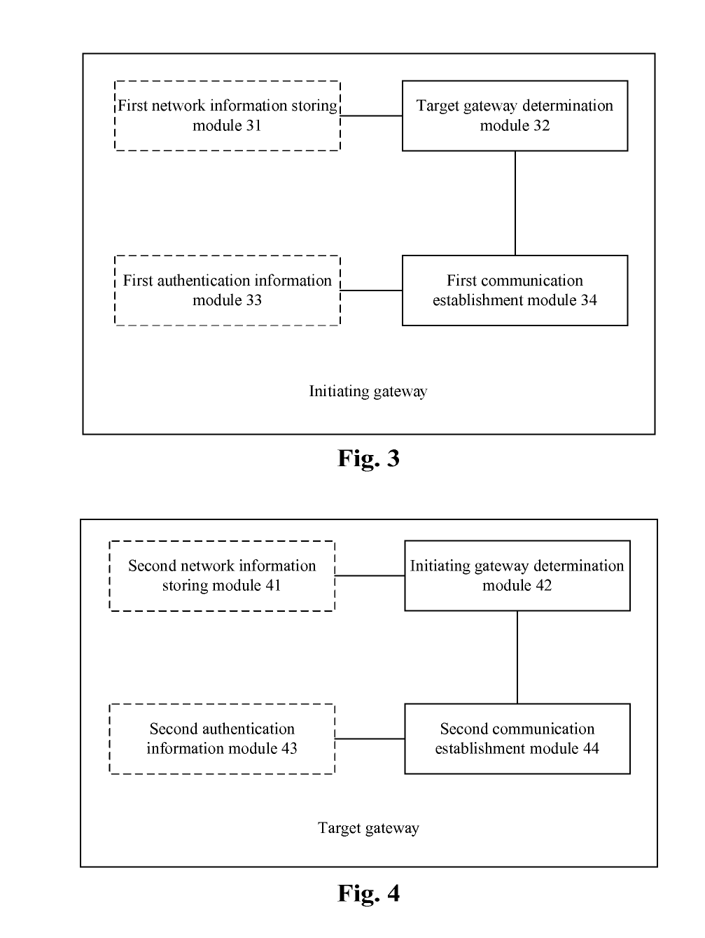

To implement the above method, an embodiment of the disclosure also provides an initiating gateway in a WSN. As shown in FIG. 3, the initiating gateway includes: a target gateway determination module 32 and a first communication establishment module 34; wherein

the target gateway determination module 32 is configured to, in a WSN configured with a plurality of gateways, determine a target gateway with which a telecommunication network communication connection is to be established;

the first communication establishment module 34 is configured to perform authentication with the target gateway, and after the authentication is successful, establish the telecommunication network communication connection.

The initiating gateway further includes: a first network information storing module 31, configured to store network information about other gateways in the WSN;

correspondingly, the target gateway determination module 32 is configured to determine the target gateway with which the telecommunication network communication connection is to be established according to the network information stored by the first network information storing module 31 about other gateways in the WSN.

The initiating gateway further includes: a first authentication information module 33, configured to notify the first communication establishment module 34 after determining that authentication information for performing communication with the target gateway is stored in the first authentication information module;

correspondingly, the first communication establishment module 34 is configured to perform authentication with the target gateway according to the authentication information stored in the first authentication information module 33.

The first authentication information module 33 is further configured to, after determining that the authentication information for performing communication with the target gateway is not stored in the first authentication information module, negotiate with the target gateway about the authentication information required for telecommunication network communication according to a communication technology employed in the WSN.

The first authentication information module 33 negotiates with the target gateway about the authentication information required for the telecommunication network communication according to the communication technology employed in the WSN, specifically: when the WSN employs the Zigbee communication technology, the first authentication information module 33 and the target gateway employ a symmetric-key key establishment (SKKE) protocol to determine a link key according to a master key which is possessed by both the first authentication information module 33 and the target gateway, and store the link key respectively as the authentication information between the initiating gateway and the target gateway.

The first communication establishment module 34 is specifically configured to send a connection establishment request to the target gateway by a point-to-point communication protocol; perform authentication for the target gateway by a symmetric-key-based authentication protocol according to the authentication information stored in the first authentication information module 33 for performing telecommunication network communication with the target gateway; after the authentication is successful and a connection establishment completion response from the target gateway is received, perform communication with the target gateway in the telecommunication network.

The first communication establishment module 34 is further configured to perform communication with the target gateway in the telecommunication network, wherein an encryption key used in the WSN is employed for encryption or decryption of data transmission.

To implement the above method, an embodiment of the disclosure also provides a target gateway in a WSN. As shown in FIG. 4, the target gateway includes: an initiating gateway determination module 42 and a second communication establishment module 44; wherein

the initiating gateway determination module 42 is configured to determine an initiating gateway with which a telecommunication network communication connection is to be established;

the second communication establishment module 44 is configured to perform authentication with the initiating gateway, and after the authentication is successful, establish the telecommunication network communication connection.

The target gateway further includes: a second network information storing module 41, configured to store network information about other gateways in the WSN;

correspondingly, the initiating gateway determination module 42 is configured to determine the initiating gateway, with which the telecommunication network communication connection is to be established, according to the network information stored by the second network information storing module 41 about other gateways in the WSN.

The target gateway further includes: a second authentication information module 43, configured to store the authentication information for performing communication with the initiating gateway; correspondingly, the second communication establishment module 44 is configured to perform authentication with the initiating gateway according to the authentication information stored in the second authentication information module 43.

The second communication establishment module 44 is specifically configured to perform authentication for the initiating gateway by a symmetric-key-based authentication protocol according to the authentication information which is stored in the second authentication information module 43 and used for performing communication with the initiating gateway, and after the authentication is successful, send a connection establishment completion response to the initiating gateway. The second communication establishment module 44 is further configured to perform communication with the initiating gateway in the telecommunication network.

The second authentication information module 43 is further configured to, together with the initiating gateway, employ an SKKE protocol to determine a link key according to a master key which is possessed by both the second authentication information module 43 and the initiating gateway, and store the link key respectively as the authentication information between the initiating gateway and the target gateway.

The second communication establishment module 44 is further configured to perform communication with the initiating gateway in the telecommunication network, wherein an encryption key used in the WSN is employed for encryption or decryption of data transmission.

Above contents just describe preferred embodiments of the disclosure and are not used for limiting the protection scope of the disclosure.

1. A method for communication between gateways in a Wireless Sensor Network (WSN), comprising:
in a WSN configured with a plurality of gateways, an initiating gateway determining a target gateway with which a telecommunication network communication connection is to be established;
the initiating gateway and the target gateway performing authentication, after the authentication is successful, establishing the telecommunication network communication connection between the initiating gateway and the target gateway.

2. The method according to claim 1, wherein the initiating gateway determining the target gateway in a telecommunication network is:
in the WSN configured with the plurality of gateways, each gateway storing network information about other gateways in the WSN;
the initiating gateway determining the target gateway, with which the telecommunication network communication connection is to be established, according to the stored network information about other gateways in the WSN.

3. The method according to claim 2, wherein each gateway storing the network information about other gateways in the WSN is: a management platform and a gateway which creates the WSN storing the network information about each gateway in the WSN, the management platform or the gateway which creates the WSN sending the network information about all gateways in the WSN to each gateway in the WSN, and each gateway in the WSN storing the network information about other gateways except the gateway itself after receiving the network information about all gateways in the WSN.

4. The method according to claim 3, wherein the network information comprises an identity (ID) of a gateway, an address of the gateway in the telecommunication network and an address of the gateway in the WSN.

5. The method according to claim 1, wherein the initiating gateway and the target gateway performing the authentication is:
the initiating gateway and the target gateway performing mutual authentication according to authentication information stored in respective gateways, wherein the authentication information is a key used by the initiating gateway and the target gateway for communication in the WSN.

6. The method according to claim 5, wherein the initiating gateway and the target gateway performing the mutual authentication according to the authentication information stored in the respective gateways is:
after determining that the authentication information for performing communication with the target gateway is stored in the initiating gateway, the initiating gateway sending a connection establishment request to the target gateway;
the initiating gateway performing authentication for the target gateway by a symmetric-key-based authentication protocol according to the authentication information which is stored in the initiating gateway and is required for performing telecommunication network communication with the target gateway;
the target gateway which receives the connection establishment request performing authentication for the initiating gateway by the symmetric-key-based authentication protocol according to the authentication information which is stored in the target gateway and is used for performing communication with the initiating gateway.

7. The method according to claim 6, further comprising: after determining that the authentication information for performing communication with the target gateway is not stored in the initiating gateway, the initiating gateway negotiating with the target gateway about the authentication information for performing the telecommunication network communication according to a communication technology employed in the WSN.

8. The method according to claim 7, wherein the initiating gateway negotiating the authentication information for performing the telecommunication network communication with the target gateway according to the communication technology employed in the WSN is:
when the WSN employs a Zigbee communication technology, the initiating gateway and the target gateway employing a symmetric-key key establishment protocol to determine a link key according to a master key which is possessed by both the initiating gateway and the target gateway, and storing the link key respectively as the authentication information between the initiating gateway and the target gateway.

9. The method according to claim 1, further comprising: the communication between the initiating gateway and the target gateway in the telecommunication network employing an encryption key, which is used in the WSN, for encryption or decryption of data transmission.

10. An initiating gateway in a Wireless Sensor Network (WSN), wherein the initiating gateway comprises: a target gateway determination module and a first communication establishment module; wherein
the target gateway determination module is configured to, in a WSN configured with a plurality of gateways, determine a target gateway with which a telecommunication network communication connection is to be established;
the first communication establishment module is configured to perform authentication with the target gateway, and after the authentication is successful, establish the telecommunication network communication connection.

11. The initiating gateway according to claim 10, further comprising:
a first network information storing module, configured to store network information about other gateways in the WSN;
correspondingly, the target gateway determination module is configured to determine the target gateway, with which the telecommunication network communication connection is to be established, according to the network information stored by the first network information storing module about other gateways in the WSN.

12. The initiating gateway according to claim 10, further comprising:
a first authentication information module, configured to notify the first communication establishment module after determining that authentication information for performing communication with the target gateway is stored in the first authentication information module;
correspondingly, the first communication establishment module is configured to perform the authentication with the target gateway according to the authentication information stored in the first authentication information module.

13. The initiating gateway according to claim 12, wherein the first authentication information module is further configured to, after determining that the authentication information for performing communication with the target gateway is not stored in the first authentication information module, negotiate with the target gateway about the authentication information for performing telecommunication network communication according to a communication technology employed in the WSN.

14. A target gateway in a Wireless Sensor Network (WSN), wherein the target gateway comprises: an initiating gateway determination module and a second communication establishment module; wherein
the initiating gateway determination module is configured to determine an initiating gateway with which a telecommunication network communication connection is to be established;
the second communication establishment module is configured to perform authentication with the initiating gateway, and after the authentication is successful, establish the telecommunication network communication connection.

15. The target gateway according to claim 14, further comprising:
a second network information storing module, configured to store network information about other gateways in the WSN;
correspondingly, the initiating gateway determination module is configured to determine the initiating gateway, with which the telecommunication network communication connection is to be established, according to the network information stored by the second network information storing module about other gateways in the WSN.

16. The target gateway according to claim 14, further comprising:
a second authentication information module, configured to store authentication information for performing communication with the initiating gateway;
correspondingly, the second communication establishment module is configured to perform the authentication with the initiating gateway according to the authentication information stored in the second authentication information module.

17. The method according to claim 2, further comprising: the communication between the initiating gateway and the target gateway in the telecommunication network employing an encryption key, which is used in the WSN, for encryption or decryption of data transmission.

18. The method according to claim 3, further comprising: the communication between the initiating gateway and the target gateway in the telecommunication network employing an encryption key, which is used in the WSN, for encryption or decryption of data transmission.

19. The method according to claim 4, further comprising: the communication between the initiating gateway and the target gateway in the telecommunication network employing an encryption key, which is used in the WSN, for encryption or decryption of data transmission.

20. The method according to claim 5, further comprising: the communication between the initiating gateway and the target gateway in the telecommunication network employing an encryption key, which is used in the WSN, for encryption or decryption of data transmission.
